(19) United States
(12) Patent Application Publication
(10) Pub. No.: US 2007/0246358 A1
(43) Pub. Date: Oct. 25, 2007

(54) Sensor Element for Determining a Physical Property of a Measuring Gas

(75) Inventors: Jens Schneider, Leonberg (DE); Detlef Heimann, Gerlingen (DE); Thomas Wahl, Pforzheim (DE); Thomas Egner, Remseck (DE); Gerhard Schneider, Pettstadt (DE); Hans-Joerg Renz, Leinfelden-Echterdingen (DE); Harald Neumann, Shanghai (CN); Andreas Schaak, Ludwigsburg (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/628,700

(22) PCT Filed: Apr. 27, 2005
(86) PCT No.: PCT/EP05/51905

§ 371 Date: Jun. 8, 2007

(30) Foreign Application Priority Data
Jun. 5, 2004 (DE) 10 2004 027 630.7

(51) Int. Cl. G01N 27/26

(52) U.S. Cl. 204/424

(57) ABSTRACT

A sensor element is described for determining a physical property of a measuring gas, in particular the pressure or the concentration of a gas component in a gas mixture, in particular in the exhaust gas of an internal combustion engine. The sensor element has an electrode exposed to the measuring gas and a reference electrode exposed to a reference gas, ambient air in particular, through a porous volume. The two electrodes are separated from one another by a solid electrolyte. To avoid premature aging of the reference electrode as a result of deposits of foreign substances contained in the reference gas or of chemical interactions caused by the foreign substances, the volume material is selected with respect to its physical and chemical properties in such a way that the foreign substances are bound in the volume and/or are subjected to a chemical reaction.

### FIELD OF THE INVENTION

The present invention is directed to a sensor element for determining a physical property of a measuring gas, in particular the pressure or the concentration of a gas component in a gas mixture, in particular in the exhaust gas from an internal combustion engine.

### BACKGROUND INFORMATION

In a known electrochemical sensor for determining the oxygen content in gas mixtures having a heating device for generating the operating temperature of the sensor element (German Published Patent Application No. 198 15 700), the volume provided with pores via which the reference electrode is connected to a reference gas channel conveying the reference gas is formed as a layer plane between the reference channel and the reference electrode and is used for improved thermal coupling between the reference electrode and the resistance heating element of the heating device, providing uniform heat distribution. In addition, the porous layer reduces increased mechanical stresses which occur on the edge of the reference gas channel toward the adjacent solid electrolyte and which may result in stress cracks in the solid electrolyte body. Furthermore, the large-surface contact of the reference electrode with the adjacent porous layer achieves improved adhesion because the reference electrode is thus held pressed between neighboring films during lamination of the solid electrolyte body which is made up of films.

In sensor elements of this type, functionality is reduced over the long term due to aging processes. This affects in particular the external sensor areas exposed to the exhaust gas of internal combustion engines where electrodes are situated. The presence of foreign substances in the exhaust gas, such as acidic exhaust gas components, e.g., phosphorus or sulfur compounds, neutral particles, and oil ashes including compounds containing Ca, P, Zn, Mn, Fe as well as lead and silicon compounds can result in deposits on, or direct chemical interactions with, the electrodes with the consequence of changed electrode activity, electrode poisoning or electrode passivation.

However, the reference gas, in particular when the ambient air in the engine compartment of a motor vehicle is used as a reference gas, also contains contaminants—even if only a small amount—which result in accelerated aging of the reference electrode. Sources of such contaminants in the reference gas or in the reference air are insulating and sealing materials as well as detergents and lubricants which are used in the motor vehicle's engine compartment.

### SUMMARY OF THE INVENTION

The sensor element according to the present invention has the advantage that through the selection of the volume material, through which the reference gas is applied to the reference electrode, with respect to its physical and chemical properties, in particular with respect to its affinity for binding the foreign substances normally present in the reference gas, the foreign substances are bound in the porous volume or enter into a chemical reaction in the porous volume and are thus unable to interact with the electrode surface of the reference electrode. Since the reference electrode is generally situated in a reference channel formed in the interior of the solid electrolyte, the requirements placed on the mechanical strength of the volume material are not high.

According to an advantageous specific embodiment of the present invention, the porous volume is designed as a porous protective layer that covers the open surfaces of the reference electrode situated on the solid electrolyte. In this connection, the protective layer is applied in the form of a paste in a specific work operation and then sintered in a cofiring process.

According to an advantageous specific embodiment of the present invention, the porous volume completely fills at least one channel segment of a reference gas channel in which the reference electrode is situated, the channel segment being located upstream from the reference electrode. In this case also, the volume material is introduced into the reference channel in the form of a paste and then sintered by cofiring so that the channel cross section is completely filled. In both cases, the porosity and layer thickness are optimized in such a way that a free gas exchange is ensured between the reference electrode and the reference gas channel without impairing the sensor function. For example, the porosity of the filling volume is 20% to 60% and the layer thickness of the porous protective layer is 5 microns to 50 microns.

### BRIEF DESCRIPTION OF THE DRAWINGS

FIG. 1 shows a cross section of a sensor element for determining the oxygen concentration in the exhaust gas of an internal combustion engine.

FIG. 2 shows a partial section along Line II-II in FIG. 1.

FIG. 3 shows a representation identical to FIG. 1 with a modification of the sensor element.

FIG. 4 shows a partial section along Line IV-IV in FIG. 3.

### DETAILED DESCRIPTION

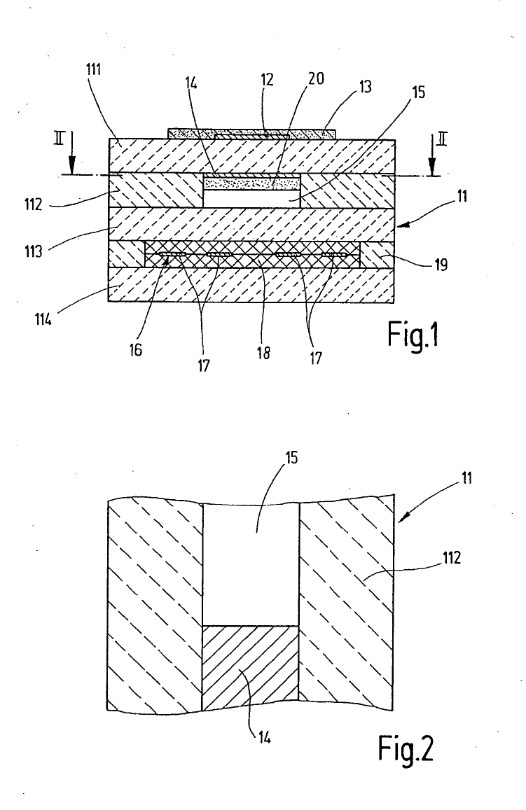

The sensor element shown in two different sectional views in FIGS. 1 and 2 for a lambda sensor, operating according to the Nernst (potentiometric) principle for measuring the oxygen concentration in the exhaust gas of an internal combustion engine, as an exemplary embodiment of a general sensor element for determining a physical property of a measuring gas, has a solid electrolyte body 11, which is made up of a plurality of oxygen-conducting solid electrolyte layers 111 through 114, which are in part designed as ceramic films such as solid electrolyte layers 111, 112, and 114 and in part as a printed layer such as solid electrolyte layer 113. Zirconium oxide (ZrO₂) fully or partially stabilized by yttrium, for example, is used as a solid electrolyte material. The integrated form of planar ceramic solid electrolyte body 11 is produced by laminating together the ceramic films printed with functional layers and subsequently sintering the laminated structure.

On first solid electrolyte layer 111, an external electrode 12 is applied to an outer surface of solid electrolyte body 11, the external electrode being covered by a protective layer 13. Protective layer 13 is designed to be porous so that external electrode 12 is exposed to the exhaust gas surrounding the sensor element through protective layer 13. A reference electrode 14 is applied to the surface of first solid electrolyte layer 11 facing away from external electrode 12. Reference electrode 14 is situated in a reference gas channel 15, which is introduced into second solid electrolyte layer 112 and is covered from above by first solid electrolyte layer 111 and from below by third solid electrolyte layer 113.

An electric resistance heater 16 is provided between third solid electrolyte layer 113 and fourth solid electrolyte layer 114 for heating the electrode area, the resistance heater having a preferably meandering heating surface 17 and two printed conductors (not shown) leading to heating surface 17 for the supply of current. Heating surface 17 and the feed conductors are embedded in an electrical insulation 18 which is laterally surrounded by a sealing frame 19. It is of course possible to omit sealing frame 19 and to route insulation 18 to the lateral surfaces of solid electrolyte body 11.

A reference gas is applied to reference gas channel 15, atmospheric air withdrawn from the engine compartment of a motor vehicle equipped with the internal combustion engine preferably being used as a reference gas. In order to protect reference electrode 14 against contamination caused by foreign substances or pollutants contained in the reference air, reference electrode 14 is not directly exposed to the reference gas or reference air but is instead exposed through a porous volume, the volume material of which is selected with respect to its physical and chemical properties in such a way that the foreign substances contained in the reference gas are bound in the volume and/or subjected to a chemical reaction. Sources of such a contamination of the reference air are insulation and sealing materials as well as detergents and lubricants which are normally used in the motor vehicle's engine compartment. The porosity of the volume is optimized so that a free gas exchange may occur between reference electrode 14 and reference gas channel 15. The volume material selected with regard to its affinity for binding the foreign substances contained in the reference gas binds these foreign substances or exposes them to a chemical reaction in the volume at the time the reference gas is diffused through the volume, so that foreign substances do not interact with the electrode surface of reference electrode 14 and are unable to cause reference electrode 14 to age prematurely.

The volume is preferably made up as follows for use of the sensor element in the exhaust gas of an internal combustion engine:

30-70% yttrium oxide (Y₂O₃)/zirconium oxide (ZrO₂)

30-70% aluminum oxide (Al₂O₃)

0-20% lithium oxide (Li₂O₃)

0-20% calcium oxide (CaO)

0-20% magnesium oxide (MgO)

0-20% titanium oxide (TiO₂)

0-20% cerium oxide (CeO₂)

In the exemplary embodiment according to FIGS. 1 and 2, the porous volume is in the form of a porous protective layer 20 which completely covers the open electrode surface of reference electrode 14. The layer thickness is, for example, 5 μm to 100 μm. In the production process of the sensor element, protective layer 20 is applied as a paste to reference electrode 14 and subsequently sintered in a cofiring process.

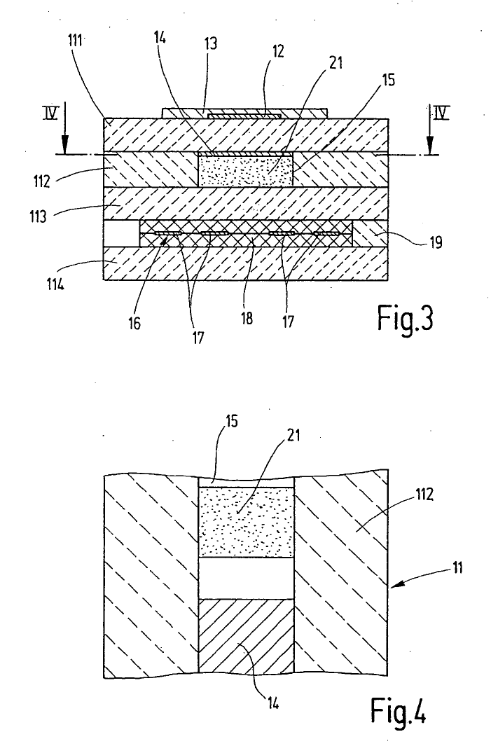

In the exemplary embodiment of FIGS. 3 and 4, the porous volume completely fills a channel segment of reference channel 15, the channel segment being upstream from reference electrode 14 as seen from the opening of reference gas channel 15. The volume in this case forms a porous protective barrier 21, through which the reference gas or the reference air is applied to reference electrode 14. Of course, it is possible to completely fill not only a channel segment but instead all of reference channel 15 with volume material. In both cases, the porosity of the volume filled into reference channel 15 is set at 20%-60%.

The present invention is not limited to the described sensor element for a lambda sensor operating according to the Nernst principle. The protection according to the present invention of reference electrode 14 against harmful contaminations in the reference gas may also be implemented in sensor elements for planar wideband sensors as described in DE 199 41 051 A1 or for λ=1 or lambda sensors designed as finger sensors as described in DE 43 12 506 A1. The present invention may also be used to the same advantage in sensor elements having a reference electrode 14 for pressure measurement in a gas, in particular in the exhaust gas of an internal combustion engine.

1.-7. (canceled)

8. A sensor element for determining a physical property of a measuring gas corresponding to a pressure or a concentration of a gas component in an exhaust gas of an internal combustion engine, comprising:
an electrode exposed to the measuring gas; and
a reference electrode exposed to a reference gas including ambient air through a porous volume, the two electrodes being separated from one another by a solid electrolyte, wherein the volume material is selected with respect to its physical and chemical properties in such a way that foreign substances contained in the reference gas are bound in the volume and/or brought to a chemical reaction.

9. The sensor element as recited in claim 8, wherein the reference electrode is situated in a reference gas channel formed in the solid electrolyte, the reference gas being applied to the reference gas channel.

10. The sensor element as recited in claim 8, wherein the reference electrode is applied to the solid electrolyte and, as a porous protective layer, the porous volume completely covers the open electrode surface of the reference electrode.

11. The sensor element as recited in claim 10, wherein the layer thickness is 5 μm to 100 μm.

12. The sensor element as recited in claim 9, wherein the porous volume completely fills at least one channel segment of the reference gas channel located upstream from the reference electrode.

13. The sensor element as recited in claim 8, wherein the porosity of the volume is 20% to 60%.

14. The sensor element as recited in claim 8, wherein the volume material is comprised of the following components in the proportions stated:

| | |
|---|---|
| Y₂O₃/ZrO₂ | 30% to 70% |
| Al₂O₃ | 30% to 70% |
| Li₂O₃ | 0% to 20% |
| CaO | 0% to 20% |
| MgO | 0% to 20% |
| TiO₂ | 0% to 20% |
| CeO₂ | 0% to 20% |
